(19) United States
(12) Patent Application Publication
(10) Pub. No.: US 2005/0119132 A1
(43) Pub. Date: Jun. 2, 2005

(54) Method and apparatus for preparing spherical crystalline fine particles

(76) Inventors: Chao-Nan Xu, Saga (JP); Wengsheng Shi, Saga (JP); Hiroshi Tateyama, Saga (JP); Keiko Nishikubo, Saga (JP)

Correspondence Address: HARNESS, DICKEY & PIERCE, P.L.C., P.O. BOX 8910, RESTON, VA, 20195, US

(21) Appl. No.: 10/497,149

(22) PCT Filed: Nov. 29, 2002
(86) PCT No.: PCT/JP02/12555

(30) Foreign Application Priority Data
Nov. 30, 2001 (JP) 2001-367296

(51) Int. Cl. H01B 1/00

(52) U.S. Cl. 505/100

(57) ABSTRACT

A spherical crystalline metal oxide particle is produced by introducing a metal ion-containing solution, which has been atomized, into an atmosphere that is kept at 1000° C. or more and under oxidizing condition, in order to concurrently dry and sinter the metal ion-containing solution. Moreover, As an apparatus for producing the particle, an apparatus is used, which is structured by connecting:

(A) a heating apparatus for concurrently drying and sintering an atomized particulate, the heating apparatus (4) including multi channel atomizing apparatus (3) having a function of atomizing a metal ion-containing solution, and a function of sorting a size of the thus atomized particulate; and (B) an electrostatic particle collecting apparatus (5) for electrostatically collecting the particle that is thus produced by (A) and has a predetermined size. With this arrangement, it is possible to provide a method and an apparatus capable of obtaining a highly crystalline spherical particle of a metal oxide safely and easily.

### TECHNICAL FIELD

The present invention relates to a method for producing a spherical crystalline particle of a metal oxide with high efficiency and easy operation, more particularly, a method for producing, with high efficiency, a nano-sized spherical crystalline particle of a metal oxide by atomizing a metal ion-containing solution into micro-mist and then applying a high temperature to the atomized metal ion-containing solution in order to concurrently dry and sinter the atomized metal ion-containing solution. The nano-sized spherical crystalline metal oxide particle is difficult to obtain as a single phase of crystal by using a conventional method. Further, the present invention relates to a producing apparatus suitably used for the method.

### BACKGROUND ART

A crystalline particle of a metal oxide is widely used as a starting material of (i) functional ceramics such as high dielectric ceramics, piezoelectric ceramics, semiconductor ceramics, ferromagnetic ceramics, and the like, and (ii) catalysts such as photo catalysts, synthesis reaction catalysts and the like.

Conventionally, the particles of the metal oxide is produced by the spray drying method, freeze drying method, condensation method, coprecipitation method, a sol-gel method, and the like. Those methods are disadvantageous in that conditions are difficult to control, their operation is complicated, and it is difficult to obtain a spherical particle having a high crystallinity.

On the other hand, various luminescent materials have been developed, which emit light by stress excitation, ultraviolet excitation, plasma excitation, electron beam excitation, electromagnetic excitation, and the like. The luminescent materials draws attention as highly luminescent material for fluorescent lamps, plasma displays, fluorescent display tubes, and solid scintillators, and for use in light accumulation.

Moreover, the inventors of the present inventions suggested a high-luminosity stress luminescent material (Japanese Publication of Unexamined Patent Application, Tokukai, No. 2001-49251 (published on Feb. 20, 2001). The high-luminosity stress luminescent material is produced from (i) a substance that contains at least one type of non-stoichiometrically composed aluminates that emit light when a mechanical external force is applied thereon, and that has a lattice defect that emits light when a carrier, which has been excited by a mechanical energy, goes back to a ground state, or (ii) a substance containing said substance and at least one of metal ions selected from rare earth metal ions and transition metal ions, said substance contained as a mother substance, and the at least one of metal ions contained as a luminescence center.

Those luminescent materials are generally produced by solid phase reaction method, specifically, by a method in which starting materials in powder form are mixed together in such amounts as to attain a predetermined composition, and then sintered at a high temperature thereby reacting the starting materials in solid phase with each other. The solid phase reaction, however, tends to result in coarse particle. Thus, the solid phase reaction method has a difficulty to obtain spherical particles having a small particle diameter.

Besides the solid phase reaction method, known is a method in which starting materials are reacted in an organic solvent thereby forming a particle. The particle produced by this method has a low crystallinity and exhibits insufficient luminance in emitting light.

In view of those circumstances, the present invention has an object of providing a method and an apparatus capable of attaining a highly crystalline spherical particle of a metal oxide with ease and safety, while overcoming the disadvantages of the conventional methods.

### DISCLOSURE OF INVENTION

As a result of various studies on methods of producing spherical crystalline particles of metal oxides, the inventors of the present invention found out that instant drying and sintering of a solution of a metal oxide is attained by atomizing the solution of a metal oxide under oxidizing condition and then introducing the atomized solution into a high temperature atmosphere, while a droplet of the solution is shaped into a spherical shape by a surface tension thereby obtaining a crystalline particle of a metal oxide in a pearl-like shape. Based on this finding, the inventors achieved the present invention.

Specifically, the present invention provides (I) a producing method of producing a spherical crystalline particle of a metal oxide, comprising the step of introducing a metal ion-containing solution, which has been atomized, into an atmosphere that is kept at 1000° C. or more and under oxidizing condition, in order to concurrently dry and sinter the metal ion-containing solution, and (II) An apparatus for producing a spherical crystalline metal oxide particle, structured by connecting: (A) a heating apparatus for concurrently drying and sintering an atomized micro-mist particulate, the heating apparatus including multi microchannel atomizing means having a function of atomizing a metal ion-containing solution, and a function of sorting a size of the thus atomized particulate of the micro-mist; and (B) an electrostatic particle collecting apparatus for electrostatically collecting the particle that is thus produced by (A) and has a predetermined size.

Additional objects, features, and strengths of the present invention will be made clear by the description below. Further, the advantages of the present invention will be evident from the following explanation in reference to the drawings.

Hereinafter, the present invention is explained in details with reference to attached drawings.

A producing method of the present invention is especially suitable for producing a highly luminescent material. For producing a highly luminescent material by using the producing method of the present invention, an apparatus is necessary, with which a spherical crystalline particle to be produced can be continuously produced with a high yield.

FIG. 1 is an explanatory view illustrating a apparatus suitable for use in performing the method of the present invention for producing of spherical crystalline metal oxide particle. A metal ion-containing solution stored in a starting material tank 1 is transferred to a multi microchannel atomizing selection device 3 via a temperature and supply amount controlling system 2 by using a supply pump. In the multi microchannel atomizing selection device 3, the metal ion-containing solution is atomized into micro-mist under oxidizing condition by using an oxidizing gas, for example an oxygen gas. Thereafter, the atomized solution is introduced into a heating apparatus 4, for example, an electric furnace. The heating apparatus 4 is kept at a temperature not less than 500° C., preferably in a range of 1000° C. to 1500° C. The metal ion-containing solution thus atomized under oxidizing condition is concurrently dried and sintered, thereby obtaining a particle of a metal oxide.

Note that the low crystallinity occurs in case where the temperature in the heating apparatus 4 is kept below 1000° C., whereas impurity phase likely occurs in case where the temperature is above 1500° C. The thus obtained particle of the metal oxide is then transferred to an electrostatic particle collecting apparatus 5, where the particle is collected electrostatically. Further, according to need, the particles are classified in terms of particle sizes, by using a temperature controlled collecting apparatus, or a collecting apparatus using a solvent.

According to a producing apparatus of the present invention, it is possible to instantly produce luminescent material of a spherical crystalline particle that need no resintering. Further, the thus obtained luminescent material has a high luminescent efficiency and no segregation in composition. Furthermore, crystalline ultrafine particles are collected with significantly high efficiency: 99% or more. Details of the producing apparatus of the present invention is explained later.

The producing method of the present invention is especially suitable for producing a highly luminescent material, which is formed by introducing a luminescence center in a mother substance.

The luminescence center may be a rare earth metal such as, Sc, Y, La, Ce, Pr, Nd, Pm, Sm, Eu, Gd, Tb, Dy, Ho, Er, Tm, Yb, Lu, or the like, preferably Eu, Ce, Tb, or Sm; or a transition metal such as Sb, Ti, Zr, V, Cr, Mn, Fe, Co, Ni, Cu, Zn, Nb, Mo, Ta, W, or the like, preferably, Mn, Cu, or Fe.

The mother substance may be an aluminate represented by general formula (1), a compound represented by general formulae (2) to (6), or a metal oxide such as Al₂O₃, SrO, MgO, ZrO₂, TiO₂, Y₃Al₅O₁₂, ZnO, LiAlO₂, CeMgAl₁₁O₁₉, and the like:
M¹ₓM²_{y}Al_{z}O_{(2x+2y+3z)/2} (1)
(where, in Formula, M¹ and M² are at least one kind of metal selected from the group consisting of alkali earth metals such as Ca, Mg, Ba, and Sr; rare earth metals such as Sc, Y, La, Ce, Pr, Nd, Pm, Sm, Eu, Gd, Tb, Dy, Ho, Er, Tm, Yb, and Lu; transition metals such as Sb, Ti, Zr, V, Cr, Mn, Fe, Co, Ni, Cu, Zn, Nb, Mo, Ta, and W; alkali metals such as Li, Na, K, Rb, and Cs; and Si, Al, In, Ga, and Ge, and may be partially substituted, and x, y, and z are integers);
   M³Al₈O₁₃ (2);
   M³₄Al₁₄O₂₅ (3);
   M³MgAl₁₀O₁₇ (4);
   M³₄Al₂SiO₇ (5); and
   M³₄Mg₂A₁₆O₂₇ (6),
(where M³ is at least one of metal selected from Ca, Ba, Sr and Mg).

The compounds represented by General Formulae (2) to (6) may be represented by General Formulae (7) to (11):
xM³O.yM⁴₂O₃.zM⁵O₂ (7),
xM³O.yM⁴₂O₃. (8),
xM³O.zM⁵O₂ (9), and
xM³O.yM⁶₂O₅ (10),
(where M³ is at least one kind of metal selected from metals such as Ca, Ba, Sr, Mg, and the like that generate divalent cation, M⁴ is at least one kind of metal selected from metals such as Al, In, Ga, La, Y and the like that generate trivalent cation, and M⁵ is at least one kind of metal selected from metals such as Si, Ge, Zr, Ti and the like that generate tetravalent cation).

In the producing method of the present invention, a feed material may be a soluble compound of a metal that constitutes these metal compounds. The soluble compound may be, for example, an inorganic salt such as nitrate, sulfate, chloride, or the like; and an organic compound such as acetate, alcoholate, malate, citrate, and the like.

Moreover, for attaining a highly luminescent material, a feed material for the rare earth metal may be one of a chloride, a nitrate, and a sulfate, which contain europium, yttrium, cerium, terbium, gadolinium, or the like. Moreover, a feed material for the transition metal may be one of chloride, hydroxide, acetate, alcoholate, sulfate, nitrate and the like salt, which contain antimony, manganese, thallium, iron, or the like.

To be used, those metal oxides are required to be brought into solution, in the producing method of the present invention. A solvent for use in making the solution, may be water, or a mixture of water with a water-miscible solvent, for example, an alcohol-based solvent such as ethyl alcohol or the like, or a ketone-based solvent such as acetone or the like.

For producing an oxide of a plurality of metals by using the producing method of the present invention, the above-mentioned metal oxides are mixed in a ratio corresponding to compositional atomic ratio of metal components contained in the metal oxide to be produced. In mixing the metal oxides, a metal ion concentration is selected usually within a range of 0.0001 mol/L to 1.0 mol/L.

To atomize this metal ion-containing solution, a high-pressure atomizer or a ultrasonic atomizer (atomizing means, spraying means) is used. In case where the high-pressure atomizer is used, the solution should be atomized via a nozzle. In order to smoothly atomize the solution via the nozzle, a surfactant, an acid, or a base may be added in a ratio of 0.01% to 1% by mass, according to need. Moreover, viscosity of the metal ion-containing solution may be adjusted by changing which type of the solvent is used.

Moreover, in order to attain better crystallinity, it is preferable to add a halogen compound that has a low melting point and acts as a flux agent. Examples of such halogen compound are: NaCl; KI; alkali hydroxides such as NaOH, and the like; and the like.

Incidentally, a pore diameter and a length of a microchannel determines how small a size of a solution particulate in an atomized form is, the solution particulate being produced by atomizing the solution of the metal oxide from the microchannel. Furthermore, the size of the solution particulate depends on a surface tension, a pressure, atomizing rate, of the solution, and a type, pressure, flow rate, of an atomizing gas. Moreover, a concentration of the solution to be used. Under the same conditions, a lower concentration gives a smaller diameter of the crystalline particle.

FIG. 2 is a cross sectional view of the multi microchannel atomizing selection device 3. The solution of the metal compound is supplied, together with pressurized gas, via an inlet 9, atomized into micro-mist via a pore of a multi channel 10, and then supplied, via an outlet 11, to a heating apparatus 4 in which the thus atomized micro-mist solution is converted into steamed particles. The multi channel has a pore whose diameter is adjusted in a range of 10 μm to 1000 μm. If necessary, the steamed particle can be controlled and sorted in size by utilizing its spatial distribution. The solution is atomized by introducing, into the multi microchannel atomizing selection device 3, the solution together with a gas and under pressure. The gas may be for example, oxygen, nitrogen, argon, diluted hydrogen, and air. Here, pressure of the gas is in a range of 10 kPa to 500 kPa.

An atomizing means used here may be a atomizing nozzle generally used. However, it is preferable to use a multi microchannel atomizing device having a function of atomizing the starting material solution and a function of sorting the atomized particle, as described above. By adjusting the pore diameter of the microchannel of the multi microchannel atomizing device in a range of 10 μm to 1000 μm, it is possible to adjust, in a range of 0.1 μm to 500 μm, the particle diameter of the atomized particle to be produced. However, for attaining efficient production of the highly crystalline spherical particle, it is advantageous to use a microchannel having a pore diameter not more than 300 μm.

In order to have an atomized particle with a small particle diameter, it is generally necessary to jet out a starting material solution low in viscosity, by using a gas high in flow rate and highly pressured. By using the multi microchannel atomizing device, it is possible to attain the atomized particulate having a particle diameter of 20 μm or less, by utilizing a low pressure of gas: 110 kPa or less. Such particle diameter has been difficult to attain by using the conventional method.

Moreover, flow current of a fog can be controlled by reducing a gas flow rate necessary for generating fine atomized particulate. Thus, it is possible to suppress a phenomenon that the particulate thus produced adheres on a wall of a heating tube in a later heating stage. Thereby, it is possible to attain significantly better yield of the spherical crystalline particle to be produced. Here, for generating a finer atomized particulate, it is preferable to arrange such that the starting material solution is heated up to a temperature in a range of from a room temperature to an evaporation temperature of the solvent.

On the other hand, as to a method of atomizing, use of a ultrasonic atomizing apparatus makes it easier to control the flow current.

Here, the ultrasonic atomizing apparatus suitable for use in the producing method of the present invention. FIG. 10 is a view illustrating an arrangement of the ultrasonic atomizing apparatus. As shown in FIG. 10, the ultrasonic atomizing apparatus has such a simple arrangement: the ultrasonic atomizing apparatus is provided with (a) a vessel 12 made of a material, for example, Teflon (registered trademark) or the like, (b) a ultrasonic transducer 13 for atomizing the starting material solution by using a ultrasonic wave, and (c) a liquid level sensor 14.

The ultrasonic atomizing apparatus atomizes, by using the ultrasonic wave, the starting material solution supplied from a starting material inlet 15 at a constant rate. By introducing a carrier gas from a gas flow inlet 16 into the vessel 12 concurrently with the atomization of the starting material solution, the starting material solution thus atomized was transferred via a fog outlet 17 to a heating apparatus 4 in the later stage.

There is no particular limit as to which type of gas that is introduced from the gas flow inlet 15. The gas may be any gas such as an oxidizing gas and a reducing gas. For example, the gas may be oxygen, nitrogen, argon, diluted hydrogen, and air, which are used in the microchannel atomizing selection device 3 mentioned above.

Moreover, in the starting material inlet 15 and the gas flow inlet 16, introduction of the starting material and the gas is not particularly limited in terms of flow rate and pressure. The introduction may be appropriately set, for example, to be carried out under reduced pressure, or under pressure.

The ultrasonic transducer 13 vibrates by the ultrasonic wave and thereby atomizes the starting material solution. There is no particular limit as to how many ultrasonic transducers 13 are used.

For example, in case where a single ultrasonic transducer (having a diameter of about 20 mm) 13 is used, it is possible to adjust an atomizing rate in a range of 0 mL/h to 300 mL/h. Thus, it is possible to atomize the starting material solution with high efficiency. Moreover, use of a plurality of transducers makes it possible to more widely adjust atomization amount. By adjusting how many ultrasonic transducers are used, it is possible to adjust production scale with ease.

Moreover, by selecting a resonance frequency of the ultrasonic transducer 13, it is possible to control the atomizing size of the starting material solution within a range of 100 nm to 10 μm. For example, where the resonance frequency is 2.4 MHz, the starting material solution thus atomized was about 3 μm in size on average.

The liquid level sensor 14 adjusts an amount of the starting material solution and protects the ultrasonic transducer 13 from being damaged by burning-on.

The particulate of the present invention thus atomized by the ultrasonic atomizing apparatus is identical with the starting material solution in terms of composition and is free from segregation. Moreover, because it is possible to heat the particulate, other conditions than the heating can be constant. The heating of the starting material solution changes surface tension of the solution. As a result, it becomes possible to adjust the size of the atomized particle by controlling the temperature inside the apparatus. Further, this arrangement is so simple, and can produce the atomized particle continuously and stably.

Note that the conventional atomizing apparatus atomizes a solution by using a neblizer or a atomizing nozzle in which a single fluid or a double fluids are used. The size of the atomized particulate largely depends on the type of the solution, and the pressure and flow rate of the gas. Moreover, in case where a steaming method is employed in atomizing, the size of the particulate dose not depend on the flow rate of the gas, but segregation in the composition of the solution tends to occur easily.

The inventors of the present invention also compares the arrangement in which the nebulizer, which required an atomizing gas, was used as a micro mist atomizing device, and the arrangement in which the ultrasonic atomizing apparatus was used. As a result, as described above, the ultrasonic atomizing apparatus can, with such a simple arrangement, continuously atomize the particulate, while controlling the fog in size in a range of nm to μm without depending on the type, pressure, flow rate, and the like, of the carrier gas. Further, the ultrasonic atomizing fog apparatus can, with such a simple arrangement, attaining the atomized particulate identical with the solution in terms of composition.

The thus atomized metal ion-containing solution should be brought into a oxidizing condition, because the atomized metal ion-containing solution is oxidized to produce the metal oxide in the next stage. However, if atomized metal ion-containing solution is an aqueous solution of the predetermined metal salt, the metal oxide can be produced by using the reducing gas without using oxygen. Thus, for producing a spherical crystalline particle that can be deteriorated by oxidation, it is advantageous to use this method.

The particulate thus atomized is introduced into the heating apparatus 4, which is kept at a high temperature: 1000° C. or more. Thereby, the particulate is instantly dried and sintered. By heating the atomized particulate at the high temperature, it is possible to finely disgregate a large-particle-diameter atomized particle that is sometimes mixed in. Thereby, it is possible to produce an even fine powder.

Note that the heating apparatus 4 connects the microchannel atomizing selection device 3 and the electrostatic particle collecting apparatus 5. The microchannel atomizing selection device 3 and the electrostatic particle collecting apparatus 5 can be connected with high air tightness by using, for example, a joint made of stainless steel.

In case where a flammable solvent is used in heating the atomized particulate at the high temperature, it is possible to directly attain the fine powder by sintering the atomized gas in an oxidizing atmosphere, for example, by sintering the atomized gas in the air, in an oxygen gas. On the other hand, in case where an inflammable solvent is used in heating the atomized particulate, the drying and sintering are concurrently carried out by applying a high temperature of 1000° C. or higher. It is important to control the temperature in this heating section, because this is a controlling point for the crystallinity and shape of the particle. Thus, the latter is advantageous for attaining the highly crystalline spherical particle. In the producing method of the present invention, it is possible to attain a spherical particle of high crystallinity at a high rate (within one minute), by controlling a high temperature section approximately of 500° C. to 1500° C.

The thus produced spherical crystalline metal oxide particle can be collected as solid, for example, by using a temperature difference and electric field. Moreover, the particle that is not collected by this method can be collected by dispersing the particle in a solvent. As this solvent, a solvent that can prevent aggregation of the particle is selected. It is possible to use an organic solvent, such as ethyl alcohol. Exhaust gas is exhausted after passing a trap.

The thus produced solid particle is, if necessary, re-sintered under reducing atmosphere, for example, in flow current of hydrogen, at a temperature in a range of 500° C. to 1700° C. It is possible to produce a spherical particle luminescent material of highly luminescent material. Here, the sintering is carried out, generally, for a period of 0.1 to 10 hours, depending on the composition of the starting material and a temperature at which the sintering is carried out. There is a conventional problem that the high-temperature sintering results in a large size of the particle, even though the high-temperature sintering attains better crystallinity. The spherical particle produced in the producing method of the present invention showed no change in the size of the particle even after the high-temperature sintering of 1700° C. Because of this, it was proved that the spherical particle produced in the producing method of the present invention is significantly stable.

Next, FIG. 3 is an explanatory view of an apparatus having an arrangement different from that of FIG. 1. The atomized particle is dried and sintered by a heating apparatus 4, and then transferred to an electrostatic particle collecting apparatus (collecting means) 5. The electrostatic collecting apparatus 5 collects the thus produced spherical crystalline metal oxide particle in the solid form by utilizing electrostatic effect. The particle that is not collected by the electrostatic collecting apparatus 5 is transferred to a temperature controlled collecting apparatus (collecting means) 6. Further, the particle is completely collected by using a wet-type collecting apparatus (collecting means) 7 in which a solvent is used. Exhaust gas from the wet-type collecting apparatus 7 is exhausted to outside after removing the solvent off by passing through a trap 8.

In this way, it is possible to efficiently manufacture the spherical crystalline metal oxide particle in a particle diameter of 1 nm to 10 μm.

In order to efficiently collect the spherical crystalline particle thus produced without allowing a foreign material to be mixed in the spherical crystalline particle, it is preferable that the electrostatic particle collecting apparatus 5 has an arrangement shown in FIG. 11. By using the apparatus, it is possible to collect the spherical crystalline particle with a high yield of 99% or more.

FIG. 11 is a view showing an arrangement of the electrostatic particle collecting apparatus 5. FIG. 12(a) is a top view of the electrostatic particle collecting apparatus 5. As shown in FIG. 11, the electrostatic particle collecting apparatus 5 is so structured that, inside an air-tight collecting apparatus 5, a plurality of collecting electrodes 20 are alternatively arranged such that a collecting electrode 20 extended from one side is followed by another collecting electrode 20 extended from the other side, and so on.

The collecting electrodes 20 have, for example as shown in FIG. 13, a double structure and are connected to switches SW1 to SW3. The spherical crystalline particle is collected by generating an electric field between the electrodes by applying a voltage on the collecting electrodes 20. A direct current voltage to be applied on each collecting electrode 20 is not particularly limited in magnitude. Thus, a voltage of 0 to about 1000V/mm may be applied thereon.

Generally, a larger voltage is necessary for collecting a particle smaller in particle diameter. Thus, by switching over the switches SW 1 to SW3 so as to control the voltage to be applied on the collecting electrodes 20, it is possible to collect the spherical crystalline particle in particle diameter widely ranging from nm to μm.

Moreover, by switching over the switches SW1 to SW3, it is possible to control the voltage applied on each collecting electrode 20 and the timing in which the voltage is applied. This arrangement is applicable for continuous production of the spherical crystalline particle.

Further, by turning on all of the switches SW1 to SW3 so as to apply a large voltage on all the collecting electrodes, it is possible to collect the spherical crystalline particle in a short time and at once.

Moreover, the arrangement in which the plurality of the collecting electrodes 20 are provided, it is possible to easily replace a malfunctioning collecting electrode, in order to be able to collect the spherical crystalline particle again.

The collecting electrodes 20 can, for example as shown in FIG. 12(b), be provided easily by forming protruded-and-recessed sections on internal surfaces facing each other in the vessel, and alternatively inserting the collecting electrodes 20 shown in FIG. 12(c) into the internal surface of the electrostatic particle collecting apparatus 5 having the protruded-and-recessed sections. Thus, it is possible to assemble and dissemble the electrostatic particle collecting apparatus 5 easily. Therefore, maintenance of the electrostatic particle collecting apparatus 5, such as washing, can be carried out easily.

The collecting electrodes 20 have a width shorter than that of the electrostatic particle collecting apparatus 5. As a result, gas containing the spherical crystalline particle in the vessel moves inside of the vessel from a flow inlet 21 in a meandering manner as indicated by dot lines in FIG. 11. Therefore, it is possible to utilize an inside of the electrostatic particle collecting apparatus 5 efficiently. As a result, it is possible to collect the spherical crystalline particle with a yield close to 100%.

The collecting electrodes 20 are not particularly limited in terms of number and area. However, the collecting electrodes 20 in a larger number and having a wider area can collect the spherical crystalline particle more certainly.

By providing the collecting electrodes 20 in a larger number, it is possible to collect the spherical crystalline particle, without providing the temperature-controlled collecting apparatus 6 and the wet-type collecting apparatus 7 shown in FIG. 5. Impurity other than the spherical crystalline particle is flown, together with the gas, from an outlet to a trap used or exhausting the gas.

As described above, the use of the electrostatic particle collecting apparatus 5 makes it possible to exclusively collect, with high efficiency, the spherical crystalline particle to be obtained.

Conventionally, for collecting the spherical crystalline particle contained in the gas, a filter is generally used. However, the use of the filter in collecting the spherical crystalline particle has a problem that impurity is mixed in the collected spherical crystalline particle.

By using the electrostatic particle collecting apparatus 5, the conventional problem does not occur and the spherical crystalline particle can be produced at a low cost because of a simple arrangement of the electrostatic particle collecting apparatus 5, and can be collected efficiently. Thus, by simply applying the voltage on the collecting electrodes 20, it is possible to collect the spherical crystalline particle in the gas continuously. Moreover, according to scale of production, a scale of the electrostatic particle collecting device 5 can be easily adjusted by changing the area or number of the collecting electrodes 20. Note that the electrostatic particle collecting apparatus 5 is widely applicable, irrespective of the type of the spherical crystalline particle to be collected by the collecting electrodes 20.

Incidentally, there is a conventional problem that the filter is likely clog up if moisture content is high in the gas. These affect a flow system of the gas and properties of the spherical crystalline particle thus produced.

In order to prevent this, the electrostatic particle collecting apparatus 5 may be further provided with a temperature controlling section (temperature controlling means) for controlling a temperature inside of the vessel. With this arrangement, it is possible to attain better crystallinity by heating the spherical crystalline particle thus collected. Further, even if a water vapor is contained in the gas that flows in to the vessel, it is possible to remove the water vapor by heating the inside the vessel, for example to about 100° C. As a result, it is possible to prevent the collecting electrodes 20 from being short-circuited due to effect of the water vapor. Further, by removing the moisture from the spherical crystalline particle thus collected, it is possible to avoid the effect of segregation and the like.

For heating the inside of the electrostatic particle collecting apparatus 5 by the temperature controlling section, an inside layer of the electrostatic particle collecting apparatus 5 may be preferably made of a material having heat resistance and a property to be electrically insulating at a high temperature. Examples of such material are Teflon (Registered Trademark) and aluminum nitride. On the other hand, for heating the inside of the electrostatic particle collecting apparatus 5 by the temperature controlling section, an outer layer of the electrostatic particle collecting apparatus 5 may be preferably made of a material that is relatively hard and has a strength and a heat conductivity, such as aluminum, stainless steel, and the like.

### BRIEF DESCRIPTION OF DRAWINGS

FIG. 1 is a view for explaining an apparatus used in a producing method of the present invention.

FIG. 2 is a cross sectional view of a microchannel atomizing selection device shown in FIG. 1.

FIG. 3 is a view for explaining an apparatus having an arrangement different from the one shown in FIG. 1.

FIG. 4 is an electronic microscopic view of a spherical particle obtained in Example 1.

FIG. 5 is an electronic microscopic view of a spherical particle obtained in Example 2.

FIG. 6 is an electronic microscopic view of a spherical particle obtained in Example 3.

FIG. 7 is an electronic microscopic view of a spherical particle obtained in Example 4.

FIG. 8 is an electronic microscopic view of a spherical particle obtained in Example 5.

FIG. 9 is an electronic microscopic view of a spherical particle obtained in Example 6.

FIG. 10 is a view showing an arrangement of a ultrasonic atomizing apparatus.

FIG. 11 is a view showing an arrangement of a electrostatic particle collecting apparatus used in the producing method of the present invention.

FIG. 12(a) is a top view of the electrostatic particle collecting apparatus shown in FIG. 11.

FIG. 12(b) is a front view of the electrostatic particle collecting apparatus shown in FIG. 11.

FIG. 12(c) is a view showing collecting electrodes of the electrostatic particle collecting apparatus shown in FIG. 11.

FIG. 13 is a circuit diagram of the collecting electrodes of the electrostatic particle collecting apparatus shown in FIG. 11.

### BEST MODE FOR CARRYING OUT THE INVENTION

Next, the present invention is explained in further details with reference to Examples, to which the present invention is not limited. Note that a surfactant used in each Example was “olfine E1010” made by Nisshin Chemical Co., Ltd.

### EXAMPLE 1

By adding 0.0046 mol of strontium nitrate (Sr(NO₃)₂), 0.01 mol of aluminum nitrate (Al(NO₃)₃.9H₂O), and 0.0004 mol of europium nitrate (Eu(NO₃)₃.2.4H₂O) into 100 mL of distilled water, a starting material solution was prepared under stirring.

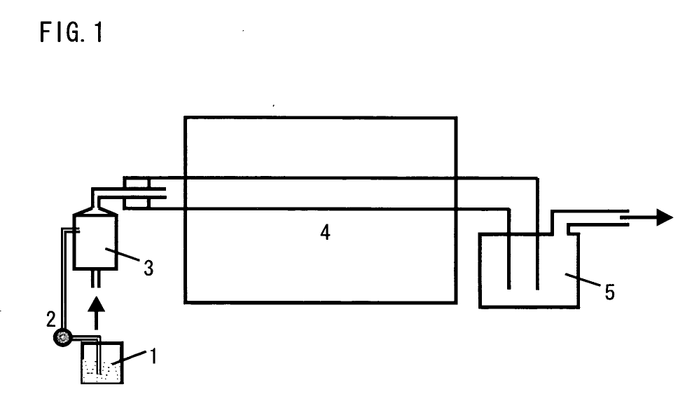

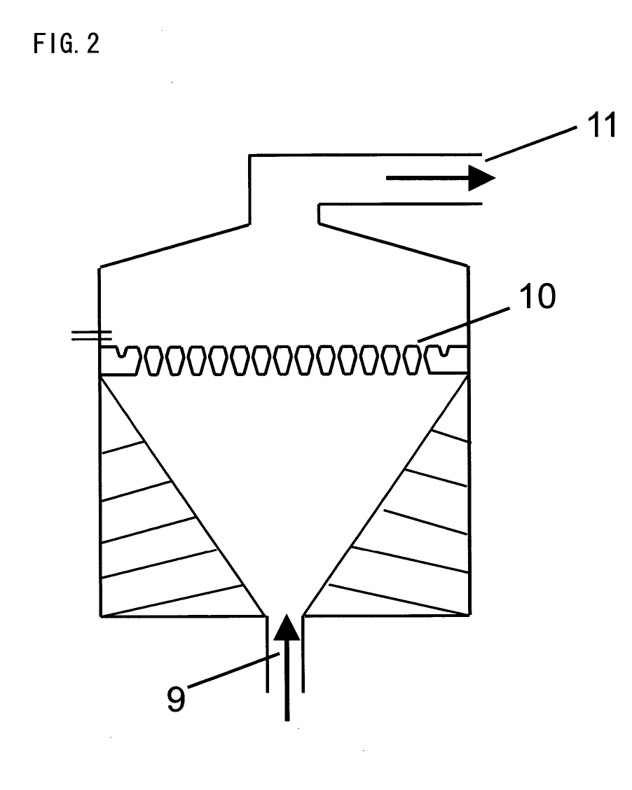

Next, by using an apparatus shown in FIG. 1, the starting material solution was atomized by flowing, at a rate of 3 L per minute, compressed argon gas containing hydrogen by 5% by volume while the starting material solution kept at 30° C. was being supplied to a micro atomizing selection device (pore size 0.2 mm in diameter) by using an automatic solution transfer pump. A particulate thus formed in atomized form was dried and sintered by passing through an electric furnace in which a maximum temperature was 1300° C. A powder particle thus produced was analyzed by X-ray. The analysis showed that the powder particle was a pure crystal of europium-containing strontium aluminate (Eu_{00.8}Sr_{0.92}) Al₂O₄, and no impure phase was found in the europium-containing strontium aluminate (Eu_{0.08}Sr_{0.92}) Al₂O₄.

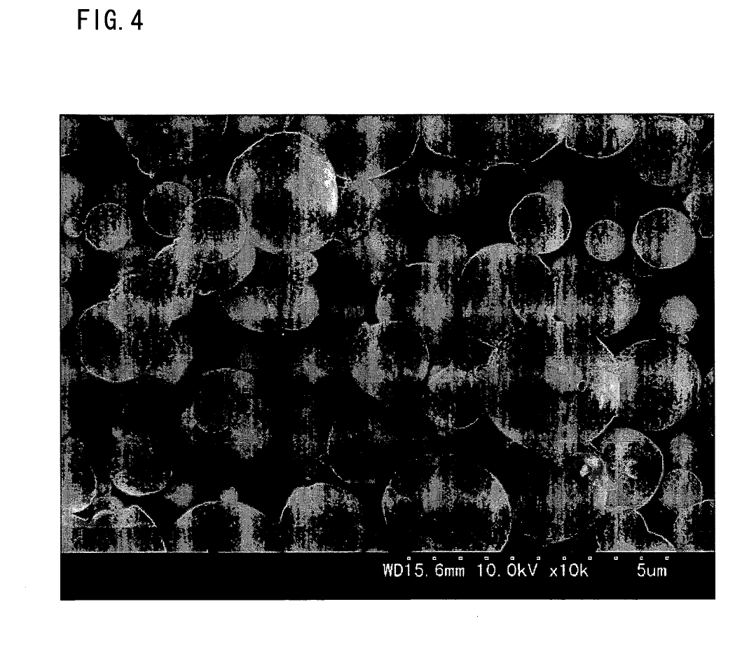

FIG. 4 shows an electronic microscopic image of the spherical particle thus obtained, which had an average particle diameter of 2 μm.

### EXAMPLE 2

By adding 0.00475 mol of strontium nitrate (Sr(NO₃)₂), 0.01 mol of aluminum nitrate (Al(NO₃)₃.9H₂O), and 0.00025 mol of europium nitrate (Eu(NO₃)₃.2.4H₂O) into a mixture of 75 mL of distilled water and 25 ml of ethyl alcohol, a starting material solution thoroughly mixed was prepared.

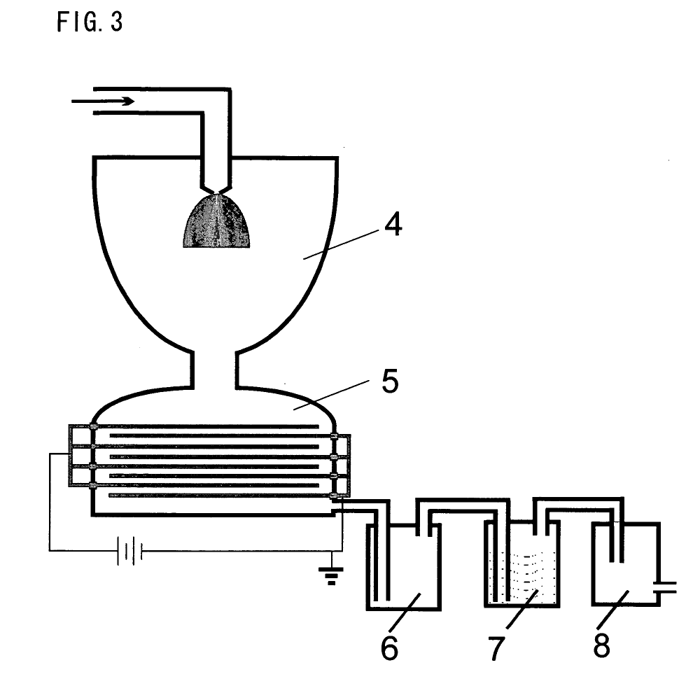

Next, by using an apparatus shown in FIG. 3, the starting material solution was atomized by flowing compressed oxygen at a rate of 3 L per minute while the starting material solution kept at 40° C. was being supplied to a micro atomizing selection device (pore size 0.1 mm in diameter) by using an automatic solution transfer pump. A particulate thus formed in atomized form was dried and sintered by passing through an electric furnace in which a maximum temperature was 1300° C., thereby producing a powder particle. The thus produced powder particle was collected primarily by using an electrostatic particle collecting apparatus, secondarily by using a temperature-controlled collecting apparatus, and tertiarily by using a collecting apparatus using a solvent. Exhaust gas was exhausted to outside after passing through a trap. The powder particle thus produced was analyzed by X-ray. The analysis showed that the powder particle was a single phase of crystal of europium-containing strontium aluminate (Eu_{0.05}Sr_{0.95}) Al₂O₄, and no impure phase was found in the europium-containing strontium aluminate (Eu_{0.05}Sr_{0.95}) Al₂O₄.

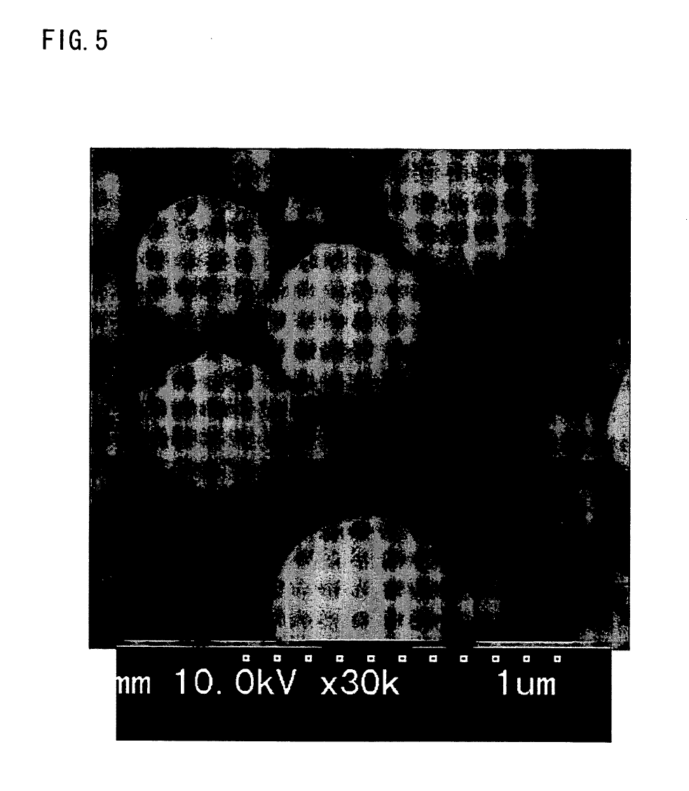

FIG. 5 shows an electronic microscopic image of the spherical particle thus obtained by using the electrostatic collecting apparatus. The spherical particle had an average particle diameter of 0.5 μm.

### EXAMPLE 3

0.00495 mol of strontium nitrate (Sr(NO₃)₂), 0.01 mol of aluminum nitrate (Al(NO₃)₃.9H₂O), and 0.00005 mol of europium nitrate (Eu(NO₃)₃.2.4H₂O) were added into a mixture of 75 mL of distilled water and 25 ml of ethyl alcohol. And then, 0.5 g of a surfactant was mixed therein. In this way, a starting material solution thoroughly mixed was prepared.

Next, by using an apparatus shown in FIG. 3, the starting material solution was atomized by flowing compressed oxygen at a rate of 1 L per minute while the starting material solution kept at 40° C. was being supplied to a micro atomizing selection device (pore size 0.1 mm in diameter) by using an automatic solution transfer pump. A particulate thus formed in atomized form was dried and sintered by passing through an electric furnace in which a maximum temperature was 1300° C., thereby producing a powder particle. The thus produced powder particle was collected primarily by using an electrostatic particle collecting apparatus, secondarily by using a temperature-controlled collecting apparatus, and tertiarily by using a collecting apparatus using a solvent. Exhaust gas was exhausted to outside after passing through a trap. The powder particle thus produced was analyzed by X-ray. The analysis showed that the powder particle was a single phase of crystal of europium-containing strontium aluminate (Eu_{0.01}Sr_{0.99}) Al₂O₄, and no impure phase was found in the europium-containing strontium aluminate (Eu_{0.01}Sr_{0.99}) Al₂O₄.

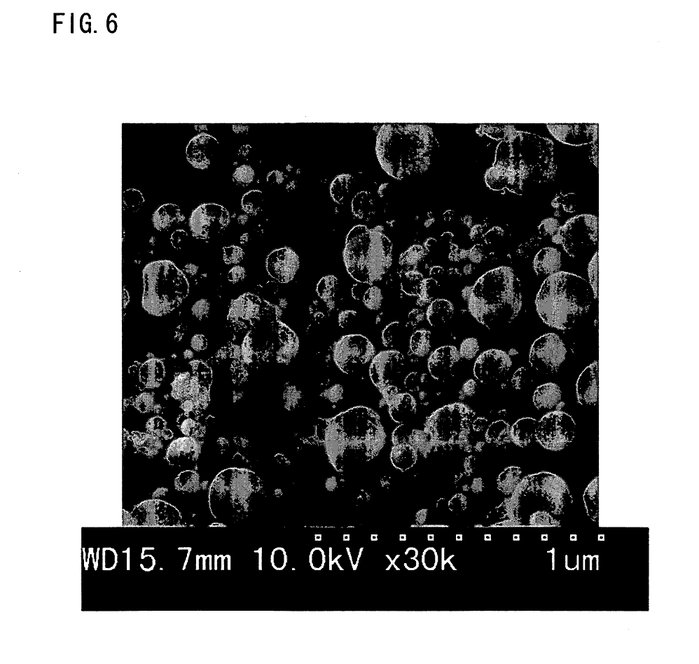

FIG. 6 shows an electronic microscopic image of the spherical particle thus obtained by using the electrostatic collecting apparatus. The spherical particle had an average particle diameter of 0.1 μm.

### EXAMPLE 4

Into a mixture of 300 mL of distilled water and 50 mL of ethyl alcohol, 0.009 mol of barium nitrate (Ba(NO₃)₂), 0.01 mol of magnesium nitrate (Mg(NO₃)₉.6H₂O), 0.1 mol of aluminum nitrate (Al(NO₃)₃.9H₂O) and 0.001 mol of europium nitrate (Eu(NO₃)₃.2.4H₂O) were added. In this way, a starting material solution thoroughly mixed was prepared.

Next, by using an apparatus shown in FIG. 3, the starting material solution was atomized by flowing 5% H₂—Ar at a rate of 3 L per minute while the starting material solution kept at 40° C. was being supplied to a micro atomizing selection device (pore size 0.2 mm in diameter) by using an automatic solution transfer pump. A particulate thus formed in atomized form was dried and sintered by passing through an electric furnace in which a maximum temperature was 1500° C., thereby producing a powder particle. The thus produced powder particle was collected primarily by using an electrostatic particle collecting apparatus, secondarily by using a temperature-controlled collecting apparatus, and tertiarily by using a collecting apparatus using a solvent. Exhaust gas was exhausted to outside after passing through a trap. The powder particle thus produced was analyzed by X-ray. The analysis showed that the powder particle was a single phase of crystal of (Eu_{0.1}Ba_{0.9}) MgAl₁₀O₁₇, and no impure phase was found in the (Eu_{0.1}Ba_{0.9}) MgAl₁₀O₁₇.

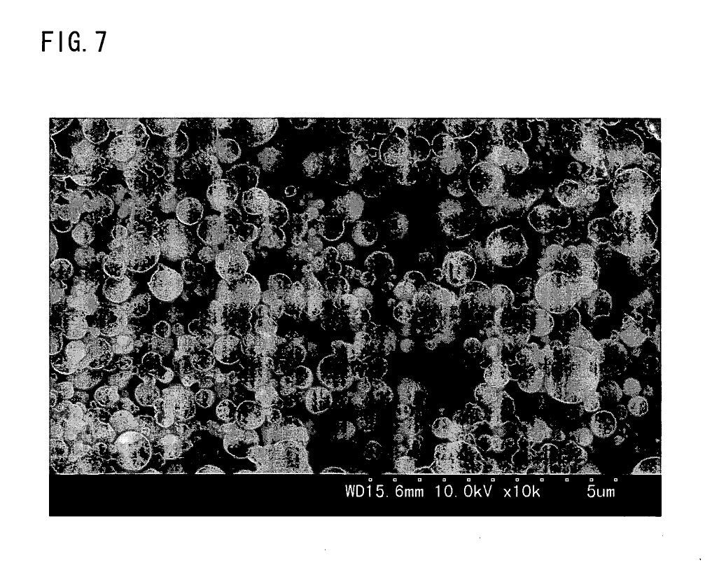

FIG. 7 shows an electronic microscopic image of the spherical particle thus obtained by using the electrostatic collecting apparatus. The spherical particle had an average particle diameter of 1 μm.

### EXAMPLE 5

Into a mixture of 300 mL of distilled water and 50 mL of ethyl alcohol, 0.0095 mol of barium acetate (Ba(CH₃COO)₂, 0.01 mol of magnesium nitrate (Mg(NO₃)₉.6H₂O), 0.1 mol of aluminum nitrate (Al(NO₃)₃.9H₂O) and 0.0005 mol of europium nitrate (Eu(NO₃)₃.2.4H₂O). In this way, a starting material solution thoroughly mixed was prepared. And then, 11.0 g of a surfactant was mixed therein. In this way, a starting material solution thoroughly mixed was prepared.

Next, by using an apparatus shown in FIG. 3, the starting material solution was atomized by flowing compressed oxygen at a rate of 3 L per minute while the starting material solution kept at 40° C. was being supplied to a micro atomizing selection device (pore size 0.1 mm in diameter) by using an automatic solution transfer pump. A particulate thus formed in atomized form was dried and sintered by passing through an electric furnace in which a maximum temperature was 1500° C., thereby producing a powder particle. The thus produced powder particle was collected primarily by using an electrostatic particle collecting apparatus, secondarily by using a temperature-controlled collecting apparatus, and tertiarily by using a collecting apparatus using a solvent. Exhaust gas was exhausted to outside after passing through a trap. The powder particle thus produced was analyzed by X-ray. The analysis showed that the powder particle was a single phase of crystal of (Eu_{0.05}Ba_{0.95})MgAl₁₀O₁₇, and no impure phase was found in the (Eu_{0.05}Ba_{0.95})MgAl₁₀O₁₇.

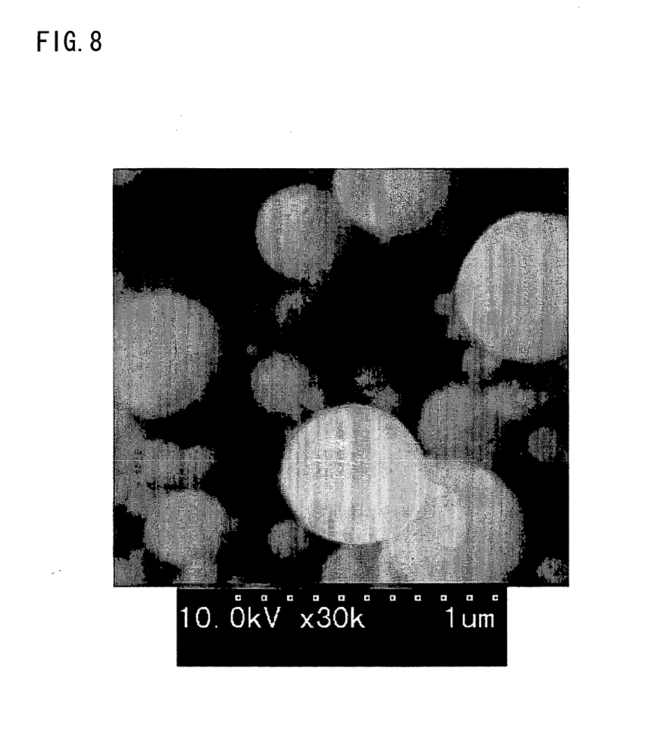

FIG. 8 shows an electronic microscopic image of the spherical particle thus obtained by using the electrostatic collecting apparatus. The spherical particle had an average particle diameter of 0.3 μm.

### EXAMPLE 6

By adding 0.04 mol of aluminum nitrate (Al(NO₃)₃.9H₂O), and 0.0004 mol of europium nitrate (Eu(NO₃)₃.4H₂O) into 40 mL of distilled water, and then stirring a mixture thereof, a starting material solution was prepared.

Next, by using an apparatus shown in FIG. 1, the starting material solution was atomized by flowing compressed argon gas at a rate of 3 L per minute while the starting material solution kept at 30° C. was being supplied to a micro atomizing selection device (pore size 0.2 mm in diameter) by using an automatic solution transfer pump. A particulate thus formed in atomized form was dried and sintered by passing through an electric furnace in which a maximum temperature was 1300° C. Thereby, a spherical particle of a single phase of crystal of europium-containing alumina was obtained. The spherical particle had an average particle diameter of 2 μm.

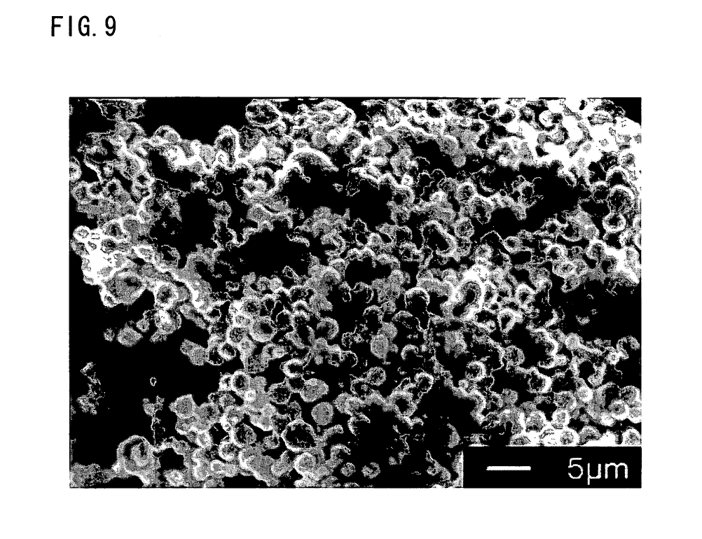

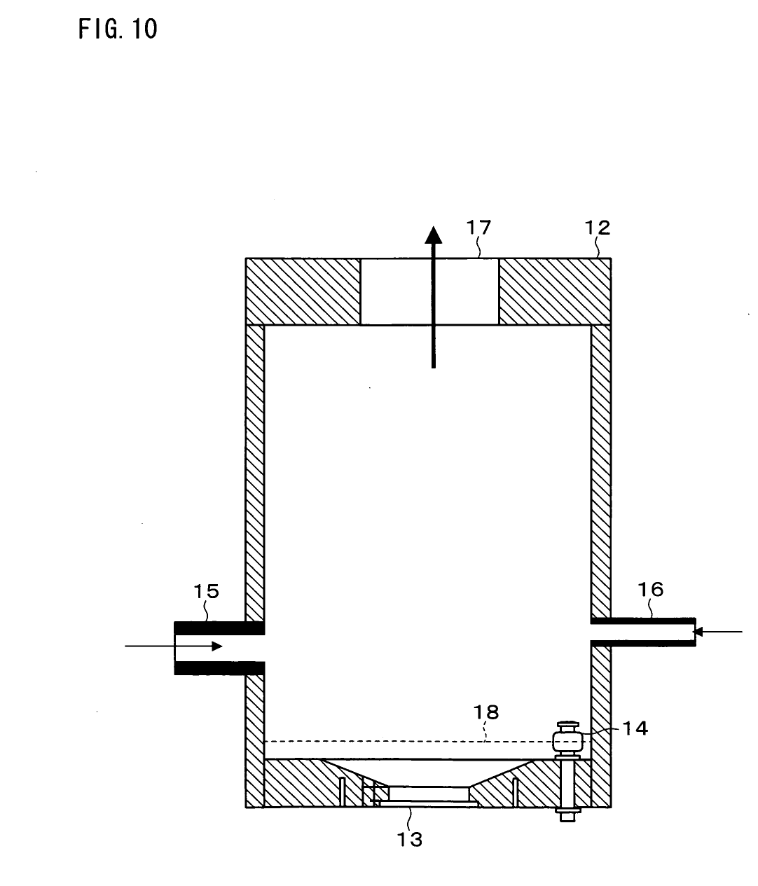

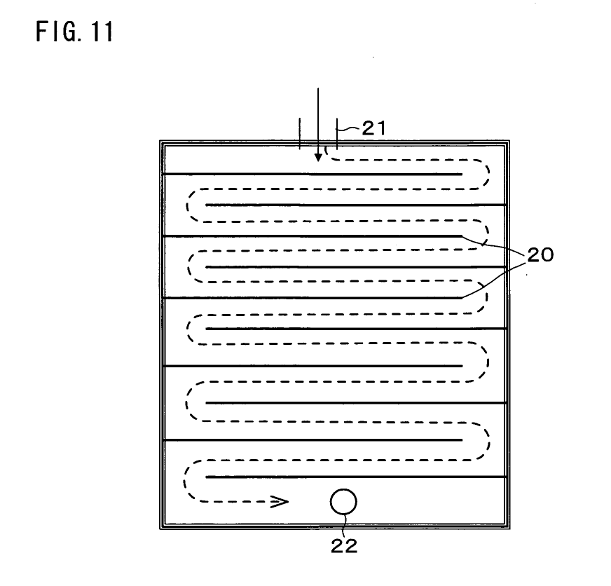

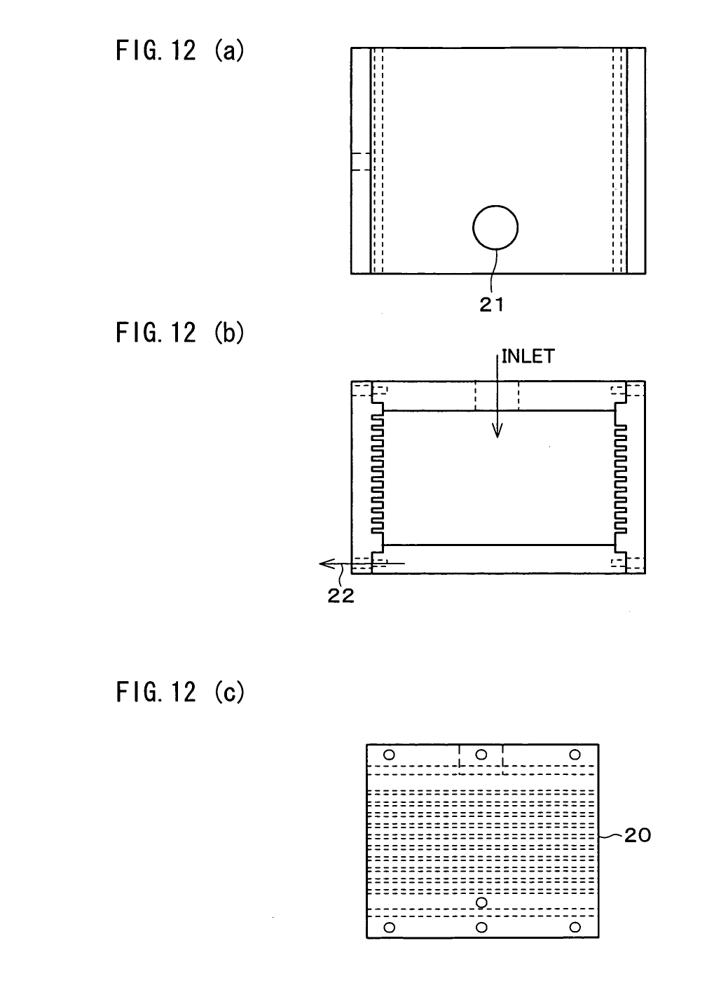

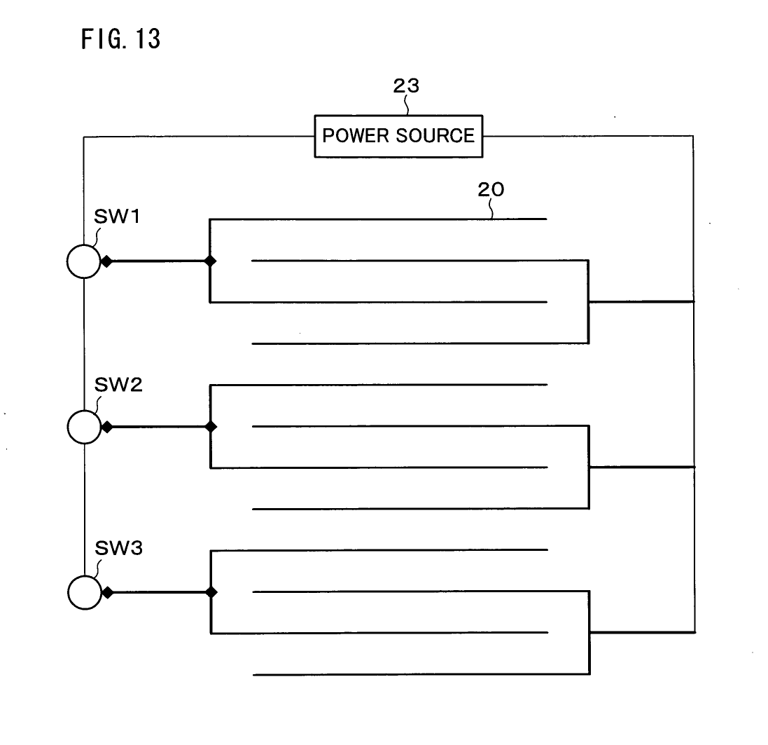

FIG. 9 shows an electronic microscopic image of this. As shown above, the single phase of crystal of alumina was obtained. It is conventionally considered that such single phase of crystal of alumina is difficult to obtain.

### EXAMPLE 7

By (i) adding 0.01 mol of aluminum nitrate (Al(NO₃)₃.9H₂O), and 0.0001 mol of europium nitrate (Eu(NO₃)₃.2.4H₂O) into a mixture of 75 mL of distilled water and 25 mL of propylalcohol, (ii) adding 0.5 g of a surfactant, and then stirring a mixture thereof, a starting material solution thoroughly mixed was prepared.

Next, by using an apparatus shown in FIG. 1, the starting material solution was atomized, where the starting material solution kept at 30° C. was supplied to a micro atomizing selection device (pore size 0.2 mm in diameter) by using an automatic solution transfer pump, while flowing compressed oxygen gas at a rate of 1 L per minute. A particulate thus formed in atomized form was dried and sintered by passing through an electric furnace in which a maximum temperature was 1300° C. Thereby, a spherical particle of a single phase of crystal of europium-containing alumina was obtained. The spherical particle had an average particle diameter of 0.2 μm.

### EXAMPLE 8

By (i) adding 0.00495 mol of strontium nitrate (Sr(NO₃)₂), 0.01 mol of aluminum nitrate nitrate (Al(NO₃)₃.9H₂O), and 0.00005 mol of europium nitrate (Eu(NO₃)₃.2.4H₂O) into a mixture of 75 mL of distilled water and 25 mL of ethyl alcohol, (ii) adding 0.5 g of a surfactant, and then (iii) stirring, a starting material solution mixed thoroughly was prepared.

Next, by using an apparatus shown in FIG. 1, the starting material solution was atomized by flowing compressed oxygen gas at a rate of 3 L per minute while the starting material solution kept at 30° C. was being supplied to a micro atomizing selection device (pore size 0.05 mm in diameter) by using an automatic solution transfer pump. A particulate thus formed in atomized form was dried and sintered by passing through an electric furnace in which a maximum temperature was 1300° C., thereby producing a powder particle. The thus produced powder particle was passed through an ordinary collecting apparatus, and then collected primarily by using an electrostatic particle collecting apparatus, then secondarily by using a temperature-controlled collecting apparatus, and tertiarily by using a collecting apparatus using a solvent. Exhaust gas was exhausted to outside after passing through a trap. This was analyzed by X-ray. The analysis showed that this was a single phase of crystal of europium-containing strontium aluminate and no impure phase was found in the europium-containing strontium aluminate.

Moreover, a spherical particle collected in the first collecting apparatus was 100 nm in average particle diameter, a spherical particle collected in the electrostatic collecting apparatus was 50 nm in average particle diameter, a spherical particle collected in the temperature controlled collecting apparatus was 20 nm in average particle diameter, and a spherical particle collected in the collecting apparatus using a solvent was 10 nm in average particle diameter.

From this, it was found out that the method of the present invention can produce a spherical particle controlled in terms of the particle diameter in a range of from nm to μm.

### EXAMPLE 9

In order to attain better crystallinity in the particles obtained in the above Examples, the particles were sintered at 1300° C. for four hours. X-ray diffraction showed that each powder particle attained had significantly better crystallinity. However, microscopic observation showed that the particles stayed unchanged in terms of its shape and particle size. From this, it was proved that the spherical particles were thermally stable significantly.

Moreover, the highly crystalline spherical particles were measured in terms of ultraviolet-stimulated luminescence intensity. It was found out that each particle system had higher luminescence intensity than starting materials obtained by the conventional solid phase reaction. Similar effects were attained in terms of stress-stimulated luminescence intensity, electronic beam-stimulated luminescence intensity. Part of results are shown on Table 1.

TABLE 1

| | | Ultraviolet- | Stress- |
|---|---|---|---|
| | | stimulated | stimulated |
| | | Luminescent | Luminescent |
| Sample | Composition | Intensity | Intensity |
| Ex. 1 | (Eu_{0.08}Sr_{0.92})Al₂O₄ | 180 | 200 |
| Ex. 2 | (Eu_{0.05}Sr_{0.95})Al₂O₄ | 150 | 160 |
| Ex. 3 | (Eu_{0.01}Sr_{0.99})Al₂O₄ | 140 | 160 |
| Ex. 4 | (Eu_{0.01}Ba_{0.9})MgAl₁₀O₁₇ | 160 | 170 |
| Ex. 5 | (Eu_{0.05}Ba_{0.95})MgAl₁₀O₁₇ | 130 | 160 |

Abbreviation: Ex. = Example.

The numeral values in the Table are relative values where corresponding compositions prepared by the conventional solid phase reaction method are put as 100.

### EXAMPLE 10

By adding 0.00475 mol of strontium nitrate (Sr(NO₃)₂), 0.01 mol of aluminum nitrate (Al(NO₃)₃.9H₂O), 0.00025 mol of europium nitrate (Eu(NO₃)₃.2.4H₂O) into a mixture of 75 mL of distilled water and 25 mL of ethyl alcohol, a starting material solution mixed thoroughly was prepared.

Next, by using an apparatus shown in FIG. 3, the starting material solution was atomized by flowing compressed oxygen at a rate of 1 L per minute while the starting material solution kept at 40° C. was being sprayed at 2.4 MHz by using a ultrasonic atomizing apparatus. Then, a particulate thus formed in atomized form was passed through an electric furnace in which a maximum temperature was 1300° C., thereby producing a powder particle. The powder particle thus produced was collected in an electrostatic particle collecting apparatus firstly. Exhaust gas was exhausted to outside after passing through a trap. As a result, europium-containing strontium aluminate (Eu_{0.05}Sr_{0.95})Al₂O₄ was obtained with 99% yield. Analysis using X-ray showed that the thus obtained particles is a single crystalline phase of europium-containing strontium aluminate (Eu_{0.05}Sr_{0.95})Al₂O₄ and no impurity was found.

FIG. 5 shows an electronic microscopic image of the spherical particle thus obtained by using the electrostatic collecting apparatus. The spherical particle had an average particle diameter of 0.5 μm.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

According to the present invention, it is possible to produce a spherical particle having a single phase of crystal of a complicate system, especially, of a complicate system that is multi-component and in which an impurity phase is easily formed. It is impossible to produce such a fine particle with a single phase of crystal of complicate system by using a conventional method.

Moreover, according to the present invention, it is possible to produce, with simple operation and in a large amount, a spherical particle of a luminescent material having a high light emission intensity. Further, it is possible to produce the particle in a smaller diameter than the particle obtained by a conventional method. For this reason, it is advantageous to employ the present invention for attaining lower energy consumption, higher resolution, higher efficiency in display apparatuses, illuminating apparatuses, and sensors.

1. A producing method of a spherical crystalline particle of a metal oxide, comprising the step of:
introducing a metal ion-containing solution, which has been atomized, into an atmosphere that is kept at 1000° C. or more and under oxidizing condition, in order to concurrently dry and sinter the metal ion-containing solution.

2. The producing method of the spherical crystalline metal oxide particle, as set forth in claim 1, wherein:
the metal ion-containing solution contains plural kinds of metal ions.

3. The producing method of the spherical crystalline metal oxide particle, as set forth in claim 1, wherein:
the metal ion-containing solution has a metal ion concentration of 0.0001 mol/L to 1.0 mol/L.

4. The producing method of the spherical crystalline metal oxide particle, as set forth in claim 1, wherein:
the spherical crystalline metal oxide particle produced by the producing method has a particle diameter in a range of 1 nm to 10 μm.

5. The producing method of the spherical crystalline metal oxide particle, as set forth in claim 1, wherein:
the metal ion-containing solution is an aqueous solution, or a mixture solution of water and a water-miscible solvent.

6. The producing method of the spherical crystalline metal oxide particle, as set forth in claim 1, wherein:
the metal ion-containing solution contains, in a ratio of 0.001% to 10% by mass, at least one of a surfactant, an acid, and a base.

7. The producing method of the spherical crystalline metal oxide particle, as set forth in claim 1, wherein:
the metal ion-containing solution is a solution of nitrate of a predetermined metal.

8. The producing method of the spherical crystalline metal oxide particle, as set forth in claim 1, wherein:
the metal ion-containing solution is atomized by introducing, under pressure, a pressurized gas into the metal ion-containing solution.

9. The producing method of the spherical crystalline metal oxide particle, as set forth in claim 8, wherein:
the pressurized gas is introduced, under pressure, into the metal ion-containing solution that is being heated to a temperature in a range of from a room temperature to an evaporating temperature of a solvent of the metal ion-containing solution.

10. A producing method of the spherical crystalline metal oxide particle, comprising the step of:
further heating, up to a temperature in a range of from 500° C. to 1700° C., the spherical crystalline metal oxide particle obtained by the method as set forth in claim 1.

11. The producing method of the spherical crystalline metal oxide particle, as set forth in claim 1, wherein:
the metal ion-containing solution contains a metal ion that includes aluminum ion.

12. A producing method of a highly luminescent material, wherein:
the producing method as set forth in claim 1 is used.

13. An apparatus for producing a spherical crystalline metal oxide particle, comprising:
atomizing means for atomizing a metal ion-containing solution;
a heating apparatus for heating an atomized particulate thus produced by the atomizing means, in order to generate a spherical particle; and
collecting means for collecting the spherical particle thus produced by the heating apparatus.

14. An apparatus for producing a spherical crystalline metal oxide particle, structured by connecting:
(A) a heating apparatus for concurrently drying and sintering an atomized particulate, the heating apparatus including multi channel atomizing means having a function of atomizing a metal ion-containing solution, and a function of sorting a size of the thus atomized particulate; and
(B) an electrostatic particle collecting apparatus for electrostatically collecting the particle that is thus produced by (A) and has a predetermined size.

15. The apparatus for producing the spherical crystalline metal oxide particle, as set forth in claim 13, wherein:
the heating apparatus is kept at a temperature of 1000° C. or more.

16. The apparatus for producing the spherical crystalline metal oxide particle, as set forth in claim 14, wherein:
the multi microchannel atomizing means has a microchannel having a pore diameter of 300μ or less.

17. The apparatus for producing the spherical crystalline metal oxide particle, as set forth in claim 13, wherein:
the atomizing means atomizes the metal ion-containing solution by using a ultrasonic wave.

18. The apparatus for producing the spherical crystalline metal oxide particle, as set forth in claim 13, wherein:
the collecting means includes, inside a collecting vessel, a plurality of collecting electrodes for collecting the spherical crystalline particle by applying a voltage on the collecting electrodes.

19. The apparatus for producing a spherical crystalline metal oxide particle, as set forth in claim 18, wherein:
the voltage is applied concurrently on all the plurality of the collecting electrodes.

20. The apparatus for producing a spherical crystalline metal oxide particle, as set forth in claim 18, wherein:
the collecting means includes a temperature controlling means for controlling a temperature inside the collecting vessel.
